(19) United States
(12) Patent Application Publication
(10) Pub. No.: US 2026/0131616 A1
(43) Pub. Date: May 14, 2026

(54) VEHICLE AIR CONDITIONER

(71) Applicants: HYUNDAI MOTOR COMPANY, Seoul (KR); KIA CORPORATION, Seoul (KR); Hanon Systems, Daejeon (KR)

(72) Inventors: Seung Hoon Moon, Hwaseong-si (KR); Yoon Hyung Lee, Hwaseong-si (KR); Sung Hae Park, Hwaseong-si (KR); Hui Beom Gwak, Hwaseong-si (KR); Myung Hoe Kim, Hwaseong-si (KR); Jun Sang Yoo, Hwaseong-si (KR); Sang Chul Byon, Daejeon (KR); Jong Su Kim, Daejeon (KR); Jin Uk Kim, Sejong-si (KR); Woo Hyun Jung, Daejeon (KR)

(73) Assignees: HYUNDAI MOTOR COMPANY, Seoul (KR); KIA CORPORATION, Seoul (KR); Hanon Systems, Daejeon (KR)

(21) Appl. No.: 19/251,319

(22) Filed: Jun. 26, 2025

(30) Foreign Application Priority Data
Nov. 13, 2024 (KR) 10-2024-0160685

(51) Int. Cl. B60H 1/00

(52) U.S. Cl. CPC B60H 1/00028; B60H 1/00735; B60H 1/00842

(57) ABSTRACT

A vehicle air conditioner includes: an air-conditioning case, an evaporator located inside the air-conditioning case, a heater unit located at a rear end of the evaporator, a case rear portion located at a rear end of the heater unit and configured to guide air that has passed through the heater unit, first inlets located facing the case rear portion, rear seat duct units respectively located at opposite sides of the air-conditioning case, the rear seat duct units being fluidly connected to the respective first inlets, and rear seat door units configured to selectively open and close the respective rear seat duct units. The rear seat duct units respectively include bent portions each configured to change a flow direction of the air such that the air introduced from the case rear portion flows toward a front end of the air-conditioning case.

### CROSS-REFERENCE TO RELATED APPLICATION

This application claims, under 35 U.S.C. § 119(a), the benefit of and priority to Korean Patent Application No. 10-2024-0160685, filed on Nov. 13, 2024, the entire contents of which are incorporated herein by reference.

### BACKGROUND

### (a) Technical Field

The present disclosure relates to a vehicle air-conditioning system, and to an air flow control technique of improving air-conditioning efficiency and maximizing space utilization in a vehicle.

### (b) Background Art

A vehicle air-conditioning system includes a device configured to control an air flow so as to efficiently control an interior temperature and provide a comfortable environment to an occupant. Particularly, a duct unit configured to transfer air to the rear seat plays an important role in air circulation and temperature control in the vehicle interior. An air flow path through which air generated in the front seat is transferred to the rear seat is designed depending on the structure of the vehicle interior. Here, arrangement of a rear seat duct unit affects utilization of the vehicle interior space.

In conventional vehicle air conditioning systems, a rear seat duct unit is disposed at the lower end of a mixing part of the front seat so as to transfer air that has passed through an evaporator and a heater unit to the rear seat. It is possible to perform air conditioning in the rear seat through this conventional method with a simple structure. Further, the conventional method is advantageous in performing basic cooling and heating while maintaining efficiency of an air flow.

However, since the rear seat duct unit is located at the lower end of the mixing part of the front seat, there is a problem in that the rear seat duct unit interferes with a sliding console. As a result, movement of the sliding console is restricted by this interference, and utilization efficiency of the vehicle interior is reduced. Particularly, since the sliding console is not freely movable, storage space of the vehicle interior may not be efficiently used, and convenience in the vehicle may deteriorate.

In order to address the above-described problems of the related art, research and development has been actively conducted to avoid interference between the rear seat duct unit and the sliding console.

The above information disclosed in this Background section is provided only to enhance understanding of the background of the disclosure, and therefore it may contain information that does not form the prior art that is already known to a person of ordinary skill in the art.

### SUMMARY

The present disclosure has been made in an effort to solve the above-described problems associated with the prior art, and the present disclosure provides an air-conditioning system configured to maintain air-conditioning performance in the rear seat without interference with a sliding console. The present disclosure utilizes vehicle interior space more efficiently by arranging a rear seat duct unit on both sides of a front seat mixing zone.

The aspects of the present disclosure are not limited to the above-mentioned features, and other technical objects not mentioned herein should be clearly understood by those having ordinary skill in the art to which the present disclosure pertains from the detailed description of the embodiments.

In one aspect of the present disclosure, a vehicle air conditioner includes: an air-conditioning case; an evaporator located inside the air-conditioning case; a heater unit located at a rear end of the evaporator; a case rear portion located at a rear end of the heater unit, the case rear portion being configured to guide air that has passed through the heater unit; and first inlets located facing the case rear portion; The vehicle air conditioner further includes: rear seat duct units respectively located at opposite sides of the air-conditioning case, the rear seat duct units being fluidly connected to the respective first inlets; and rear seat door units configured to selectively open and close the respective rear seat duct units. In particular, the rear seat duct units respectively include the first inlets and bent portions, and each of the bent portions is configured to redirect the air introduced from the case rear portion toward a front end of the air-conditioning case.

In an embodiment, the vehicle air conditioner may further include: a case front portion located between the evaporator and the heater unit, the case front portion being configured to guide air that has passed through the evaporator; and second inlets facing the case front portion. In particular, the rear seat duct units may be fluidly connected to the respective second inlets.

In another embodiment, the rear seat door units may include first doors configured to open and close the respective first inlets, and second doors configured to open and close the respective second inlets.

In still another embodiment, each of the rear seat duct units may include a temperature control area adjacent to the second inlet, and each of the temperature control areas is configured to mix air introduced through a corresponding first inlet among the first inlets with air introduced through a corresponding second inlet among the second inlets.

In yet another embodiment, the vehicle air conditioner may further include a controller configured to receive an interior temperature from a vehicle interior sensor and to operate the first doors and the second doors.

In still yet another embodiment, when the interior temperature of a rear seat is lower than a set temperature by more than a preset allowable range, the controller may be configured to control the first doors so as to open the respective first inlets and control the second doors so as to close the respective second inlets.

In a further embodiment, when the interior temperature of a rear seat exceeds a set temperature by more than a preset allowable range, the controller may be configured to control the first doors so as to close the respective first inlets and control the second doors so as to open the respective second inlets.

In another further embodiment, the controller may be configured to, when the interior temperature of a rear seat is lower than a set temperature and a difference between the interior temperature of the rear seat and the set temperature falls within an allowable range, control the first doors so as to increase respective opening degrees of the first doors.

In still another further embodiment, the controller may be configured to, when the interior temperature of a rear seat exceeds a set temperature and a difference between the interior temperature of the rear seat and the set temperature falls within an allowable range, control the second doors so as to increase respective opening degrees of the second doors.

In yet another further embodiment, the heater unit may include a PTC heater located adjacent to the first inlets, and an interior condenser located between the evaporator and the PTC heater.

In still yet another further embodiment, each of the bent portions may include an extension portion protruding from an outer surface of a rear end of the air-conditioning case.

In an embodiment, a vehicle air conditioner comprises: an air-conditioning case; an evaporator located inside of the air-conditioning case; a heater unit located at a rear end of the evaporator; a case rear portion located at a rear end of the heater unit and configured to guide air that has passed through the heater unit; a case front portion located between the evaporator and the heater unit and configured to guide air that has passed through the evaporator; a pair of rear seat duct units respectively disposed on opposite sides of the air-conditioning case, each rear seat duct unit including a first door and a second door; and a controller configured to respectively control the first and second doors to adjust amounts of air introduced from the evaporator and the heater unit, respectively.

In another embodiment, each of the pair of rear seat duct units comprises: a first inlet configured to pass the air from the heater unit; a second inlet configured to pass the air from the evaporator; and a temperature control area adjacent to the second inlet, the temperature control area configured to mix the air introduced through the first inlet with the air introduced through the second inlet.

In another embodiment, the pair of rear seat duct units respectively extend from a rear end of the air-conditioning case to a front end of the air-conditioning case along lower end surfaces of the opposite sides of the air-conditioning case.

Other aspects and embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a perspective view of an air conditioner according to an embodiment of the present disclosure;

FIG. 2 is a perspective view of a rear seat duct unit according to the embodiment of the present disclosure;

FIG. 3A is a cross-sectional side view of the air conditioner according to the embodiment of the present disclosure;

FIG. 3B is a plan view of a section taken along line A-A in FIG. 3A, according to the embodiment of the present disclosure; and

FIG. 3C is a side view of a section taken along line B-B in FIG. 3B, according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the present disclosure is described in conjunction with some embodiments, it should be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part” and “unit” described in the specification mean a unit configured to process at least two functions or operations, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

When a portion “comprises” or “includes” a certain component throughout the specification, this means that the portion may further comprise or include other components without excluding the other components unless stated otherwise. Further, terms such as “unit”, and “part” described in the specification mean a unit configured to process at least two functions or operations.

Moreover, a controller 400 may be implemented by an algorithm configured to control the operation of various components disposed in the vehicle, a memory configured to store data constituting a program that reproduces the algorithm, and a processor configured to perform the above-described operation using data stored in the memory. In this case, the memory and the processor may be implemented as separate chips. Alternatively, the memory and the processor may be implemented as a single chip. For example, the controller 400 may include at least two of an electronic controller (ECU), a central processing unit (CPU), a microprocessor unit (MPU), a microcontroller unit (MCU), an application processor (AP), or any type of processor well known in the technical field of the present disclosure.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

Furthermore, the controller 400 may be formed of a combination of software and hardware capable of performing an operation on at least two applications or programs for executing a method according to embodiments of the present disclosure.

Additionally, in the specification below, a front end refers to a direction of an inlet end of an air-conditioning case 100, and a rear end refers to an opposite direction thereto.

Hereinafter, embodiments will be described in detail with reference to the accompanying drawings. In describing the embodiments with reference to the accompanying drawings, the same or corresponding components will be denoted by the same reference numerals and redundant description thereof will be omitted.

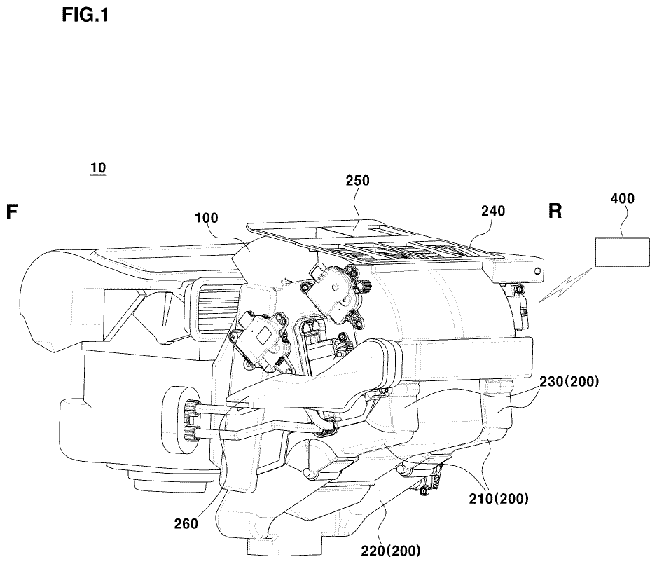

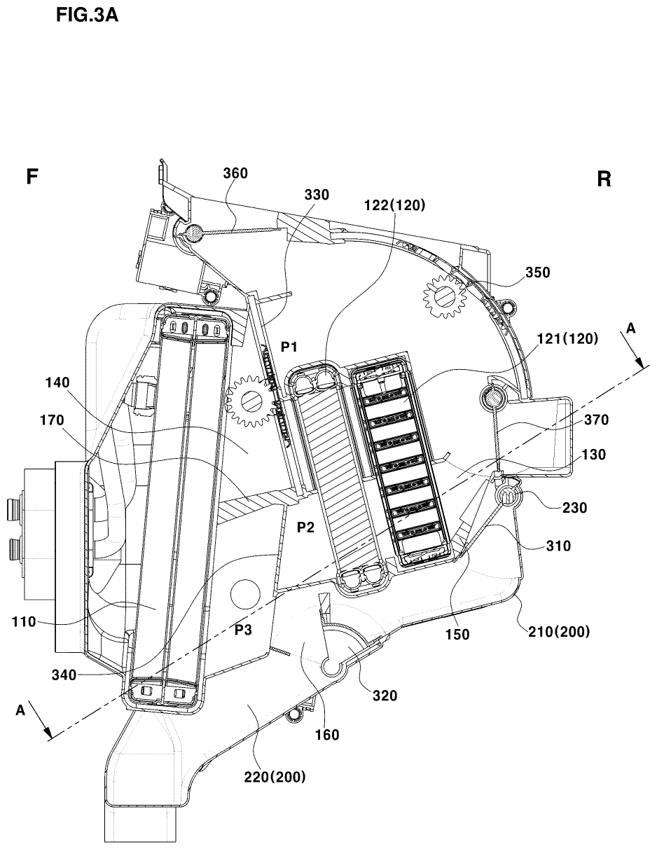

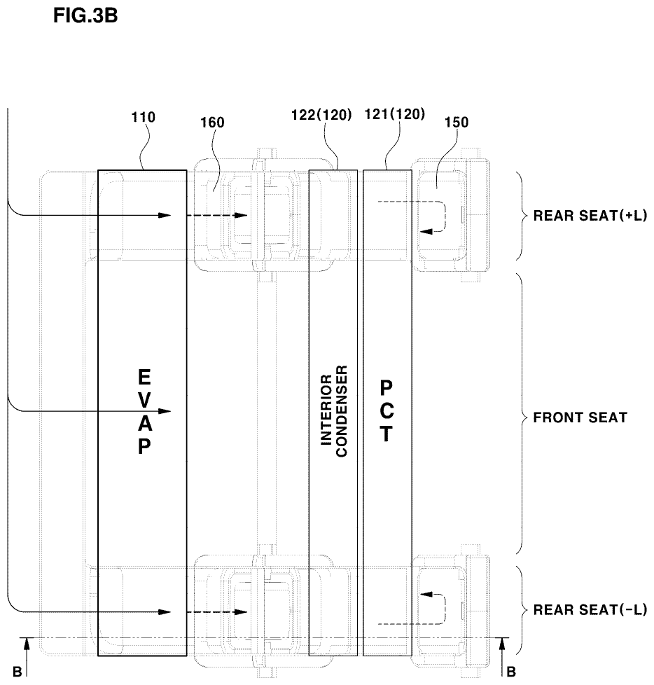

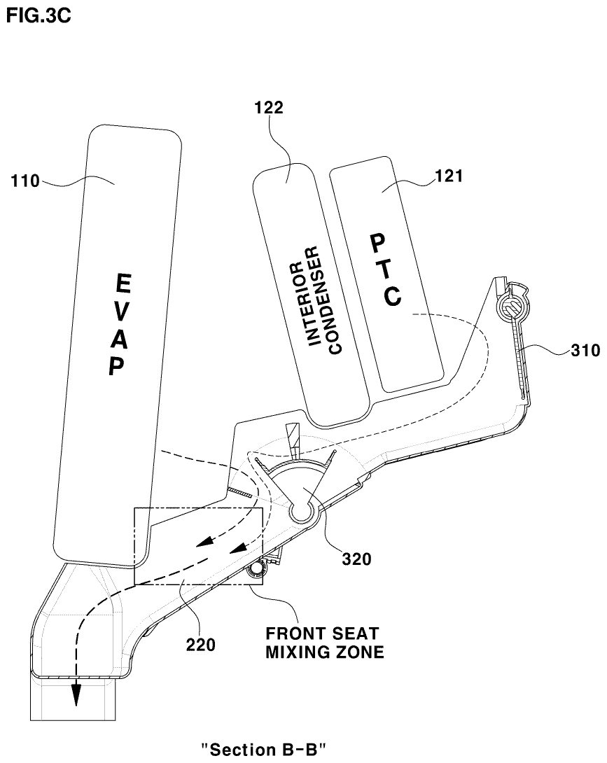

FIG. 1 is a perspective view of a vehicle air conditioner 10, and FIG. 3A is a cross-sectional side view of the air conditioner.

According to an embodiment of the present disclosure, the vehicle air conditioner 10 includes: an air-conditioning case 100, an evaporator 110, a heater unit 120, a face vent 240 fluidly connected to the air-conditioning case 100, a defrost vent 250, a front seat foot vent 260, and a face door 350 configured to open and close each of the vents, a defrost door 360, and a front seat foot door 370. In addition, the vehicle air conditioner 10 may include a rear seat duct unit 200 including a bent portion 210, and a rear seat door unit 300 configured to open and close the rear seat duct unit 200.

The evaporator 110 is located inside the air-conditioning case 100 and may be located adjacent to the inlet end of the air-conditioning case 100 through which air is introduced. The evaporator 110 is configured to lower the temperature and humidity of the introduced air. The temperature of the air passing through the evaporator 110 is lowered, and then the air is discharged to the front and rear seats of a vehicle.

The heater unit 120 is located inside the air-conditioning case 100 and is located at the rear end of the evaporator 110. In an embodiment, the heater unit 120 may be located at the rear end of the air-conditioning case 100. Furthermore, the heater unit 120 may include: an interior condenser 122 configured to convert gaseous refrigerant into liquid refrigerant, and a positive temperature coefficient (PTC) heater 121. In addition, the PTC heater 121 is located at the rear end of the interior condenser 122 and increases the temperature of the introduced air.

An air passage may be partitioned by a partition wall inside the air-conditioning case 100. The air passage of the air-conditioning case 100 is formed between the evaporator 110 and the heater unit 120, and air that has passed through the evaporator 110 flows through a case front portion 140, and a case rear portion 130 formed at the rear end of the heater unit 120 is configured to allow air that has passed through the heater unit 120 to flow therethrough.

In addition, the air passage includes a first flow path P1 connecting the upper side of the rear end of the evaporator 110 to the upper end of the inner surface of the air-conditioning case 100, and a second flow path P2 connecting one side of the evaporator 110 to the other side of the heater unit 120. Furthermore, the air passage may include a third flow path P3 connecting the lower side of the rear end of the evaporator 110 to the lower end of the inner side of the air-conditioning case 100. Additionally, the second flow path P2 may be partitioned into upper and lower sides by a partition wall 170.

In an embodiment, a temperature door is provided between the evaporator 110 and the heater unit 120, and the temperature door includes a first temperature door 330 located between the first flow path P1 and the second flow path P2 and a second temperature door 340 located between the second flow path P2 and the third flow path P3. Further, the first temperature door 330 is configured to selectively open and close the first flow path P1 and the second flow path P2, and the second temperature door 340 is configured to selectively open and close the second flow path P2.

When the first temperature door 330 and the second temperature door 340 are moved to fully open the second flow path P2, the first flow path P1 is closed.

For example, when the second flow path P2 is fully opened, the first flow path P1 is closed such that all of the air that has passed through the evaporator 110 flows into the heater unit 120, exchanges heat in the heater unit 120, and then flows to the upper end of the air-conditioning case 100 and the lower end of the air-conditioning case 100.

In addition, when the second flow path P2 is partially opened, and when the first flow path P1 and the third flow path P3 are also opened, the low-temperature air that has passed through the evaporator 110 flows into the upper end and the lower end of the air-conditioning case 100 through the first flow path P1 and the third flow path P3, respectively. Thus, the low-temperature air may be mixed with the air that has passed through the heater unit 120 through the second flow path P2 at the upper end of the air-conditioning case 100 and the lower end of the air-conditioning case 100.

Furthermore, when the second flow path P2 is fully closed, the first flow path P1 is opened. In this case, the low-temperature air that has passed through the evaporator 110 may flow into the upper end of the air-conditioning case 100 and the lower end of the air-conditioning case 100 without passing through the heater unit 120.

Moreover, the air flowing to the lower end of the air-conditioning case 100 may flow to the upper end of the air-conditioning case 100 along the outer periphery of the

### Heater Unit 120.

In this manner, the air at the upper end of the inside of the air-conditioning case 100 may flow to the face vent 240 and the defrost vent 250. Thereafter, the air may be discharged to the front seat. Here, the air that has passed through the lower end of the inside of the air-conditioning case 100 and the heater unit 120 may flow to the rear seat duct unit 200 and may be discharged to the rear seat.

A first inlet 150 may be positioned to face the case rear portion 130 and may be provided at least one of both sides of the lower end of the case. The air that has passed through the case rear portion 130 may flow to the rear seat through the first inlet 150.

A second inlet 160 may be positioned to face the case front portion 140 and may be provided at least one of both sides of the front end of the case. Here, the air that has passed through the case front portion 140 may pass through the second inlet 160 and may be discharged to the rear seat.

The rear seat duct unit 200 is located on both sides of the air-conditioning case 100 and is configured to be fluidly connected to the first inlet 150 and the second inlet 160. In an embodiment, the rear seat duct unit 200 may be configured to extend in the longitudinal direction from the rear end of the air-conditioning case 100 to the front end of the air-conditioning case 100 along the lower end surfaces of both sides of the air-conditioning case 100.

In addition, the rear seat duct unit 200 includes the first inlet 150. Further, the rear seat duct unit 200 includes the bent portion 210 configured to change the flow direction of air introduced from the case rear portion 130 such that the air flows to the front end of the air-conditioning case 100.

The bent portion 210 may be formed in an “L” shape and may be configured in a shape in which a duct parallel to the vehicle height direction is connected to a duct having a predetermined angle relative to the vehicle height direction. Additionally, the predetermined angle may vary depending on the shape of the lower portion of the air-conditioning case 100. Through this structural configuration, the bent portion 210 may change the flow direction of air introduced into the first inlet 150. According to the embodiment of the present disclosure, the bent portion 210 may change the flow direction of the air by 180 degrees with respect to the flow direction of the air passing through the first inlet.

According to another embodiment of the present disclosure, the bent portion 210 changes the flow direction of the air at an obtuse angle relative to the flow direction of the air that has passed through the first inlet 150. The obtuse angle refers to an angle between the inflow direction vector of the air and the air flow direction vector after the change of the flow direction, the angle being greater than 90 degrees and less than 180 degrees. However, the angle between the inflow direction vector of the air introduced into the first inlet 150 and the air flow direction vector after the flow direction change may have various angles, and the present disclosure is not limited to the embodiments in this specification.

In addition, the bent portion 210 is configured to include an extension portion 230 protruding from the outer surface of the rear end of the air-conditioning case 100. Furthermore, the end of the extension portion 230 may be formed as a curved surface. The extension portion 230 may be configured to prevent turbulence that may occur when air introduced through the first inlet 150 is rapidly changed in flow direction through the bent portion 210. In an embodiment, air that has passed through the first inlet 150 is gradually changed in flow direction along the curved surface of the extension portion 230 and then is guided to the rear seat.

In addition, the rear seat duct unit 200 is configured to include a temperature control area 220 in which air introduced through the first inlet 150 and air introduced through the second inlet 160 are mixed. Moreover, the rear seat duct unit 200 may be fluidly connected to a console vent (not shown) and a rear seat vent (not shown).

In an embodiment, the rear seat door unit 300 includes a first door 310 configured to open and close the first inlet 150 and a second door 320 configured to open and close the second inlet 160. In the same manner as that of the first inlet 150 and the second inlet 160, at least one first door 310 and at least one second door 320 may be respectively provided on both sides of the lower end of the air-conditioning case 100.

The first door 310 is located at a position where the first inlet 150 and the rear seat duct unit 200 are connected to each other. Here, when the temperature of the rear seat needs to be increased, the first inlet 150 is opened in response to a signal from the controller 400 so as to fluidly connect the air-conditioning case 100 to the rear seat duct unit 200. Through this structural configuration, high-temperature air that has passed through the heater unit 120 may be discharged to the rear seat after passing through the first inlet 150 and flowing into the bent portion 210.

The second door 320 is disposed at a position where the second inlet 160 and the rear seat duct unit 200 are connected to each other. Here, when the temperature of the rear seat needs to be lowered, the second inlet 160 is opened in response to a signal from the controller 400 so as to fluidly connect the air-conditioning case 100 to the rear seat duct unit 200. When the second door 320 is rotated to open the second inlet 160, low-temperature air that has passed through the evaporator 110 may be discharged to the rear seat after passing through the second inlet 160.

The temperature control area 220 is located adjacent to the second inlet 160. The temperature control area 220 is an area where air that has passed through the first inlet 150 and air that has passed through the second inlet 160 are mixed. In other words, the air that has passed through the first inlet 150 and the air that has passed through the second inlet 160 are mixed in the temperature control area 220, and the mixed air may be discharged to the rear seat.

The face vent 240 is connected to the rear end of the upper end of the air-conditioning case 100 and serves as a passage through which air inside the air-conditioning case 100 is discharged to the upper side of a driver on the front seat. The defrost vent 250 is connected to the front end of the upper end of the air-conditioning case 100 and serves as a passage through which air inside the air-conditioning case 100 is discharged to the windshield of the vehicle. The front seat foot vent 260 is connected to both sides of the air-conditioning case 100 and serves as a passage through which air flows to the lower side of the front seat.

The vehicle air conditioner 10 includes, at the inside of the air-conditioning case 100, the face door 350 disposed at a position where the face vent 240 and the air-conditioning case 100 face each other, the defrost door 360 disposed at a position where the defrost vent 250 and the air-conditioning case 100 are connected to each other, and the front seat foot door 370 disposed at a position where the front seat foot vent 260 and the air-conditioning case 100 are connected to each other.

The controller 400 controls the face door 350, the defrost door 360, and the front seat foot door 370 in response to an air-conditioning mode according to user input. Furthermore, the controller 400 may control a rear seat electric door (not shown) in response to the air conditioning-mode according to user input.

Here, the air-conditioning mode is configured to include a vent mode in which air is discharged to the upper side of the front passenger seat, a front seat foot mode in which air is discharged to the lower side of the front passenger seat, a defrost mode in which air is discharged to the windshield of the vehicle, a bi-level mode in which air flows to the upper and lower sides of the front passenger seat, and a mix mode in which air is discharged to the windshield of the vehicle and the lower side of the front passenger seat. In addition, the air-conditioning mode is configured to include a console mode in which air is discharged to the rear seat through a console vent (not shown) and a rear seat vent mode in which air is selectively discharged to the lower side of the rear seat and both sides of the rear seat.

Moreover, the air-conditioning mode in which air is discharged to the front seat and the air conditioning mode in which air is discharged to the rear seat may be controlled independently.

For example, when the air-conditioning mode is the vent mode, the controller 400 controls the face door 350 so as to open the face vent 240. In this case, air is discharged to the upper side of the front seat. When the air-conditioning mode is the front seat foot mode, the controller 400 controls the front seat foot door 370 so as to open the front seat foot vent 260. In this case, air is discharged to the front seat foot vent 260.

In addition, when the air-conditioning mode is the bi-level mode, the controller 400 controls the face door 350 and the front seat foot door 370 so as to open the face vent 240 and the foot vent. In this case, air is discharged to the upper and lower sides of the front seat.

Furthermore, when the air-conditioning mode is the mix mode, the controller 400 controls the defrost door 360 and the front seat foot door 370 so as to open the defrost vent 250 and the foot vent. In this case, air is discharged to the windshield of the vehicle and the lower side of the front passenger seat. When the air conditioning mode is a defogging mode, the controller 400 controls the defrost door 360 so as to open only the defrost vent 250 such that air is discharged only to the windshield of the vehicle.

The air-conditioning mode described above determines a direction in which air is discharged. When temperature control is required, air that has undergone heat exchange through the operations of the first temperature door 330, the second temperature door 340, the first door 310, and the second door 320 may be discharged to each of the vents.

In addition, the controller 400 receives the temperature information of the vehicle interior from an interior temperature sensor and controls the first temperature door 330, the second temperature door 340, the first door 310, and the second door 320 so as to maintain a set temperature.

According to the embodiment of the present disclosure, a description is given below as to an operation relationship between the respective doors and an air flow depending on the temperature of the vehicle interior when the air-conditioning mode is the rear seat vent mode.

In detail, when the temperature of the vehicle interior is lower than the set temperature stored in the controller 400, the controller 400 controls the first temperature door 330 and the second temperature door 340 so as to open the second flow path P2, thereby increasing the temperature of the vehicle interior. Further, the controller 400 moves the first door 310 so as to open the first inlet 150. To prevent the high-temperature air that has passed through the heater unit 120 from being discharged to the front seat due to the opening of the second flow path P2, the controller 400 controls the face door 350, the defrost door 360, and the front seat foot door 370 so as to close the face vent 240, the defrost vent 250, and the front seat foot vent 260.

In this case, the high-temperature air that has passed through the heater unit 120 is introduced into the first inlet 150 through the case rear portion 130. The high-temperature air introduced through the first inlet 150 passes through the bent portion 210 and is discharged to the rear seat. In an embodiment, the high-temperature air introduced into the first inlet 150 may flow along the curved surface of the extension portion 230 such that the flow direction of the air may be gradually switched to the front end of the air-conditioning case 100.

Conversely, when the temperature of the vehicle interior is higher than the set temperature stored in the controller 400, the controller 400 controls the first temperature door 330 and the second temperature door 340 so as to close the second flow path P2, thereby lowering the temperature of the vehicle interior. In addition, the controller 400 moves the second door 320 so as to open the second inlet 160. At this time, low-temperature air that has passed through the evaporator 110 is introduced through the second inlet 160 fluidly connected to the case front portion 140, and is discharged to the rear seat. Furthermore, the controller 400 may discharge the air to the front seat according to the front seat air-conditioning mode.

In addition, when the vehicle requires air blowing, or when the interior temperature is equal to the set temperature stored in the controller 400, the controller 400 controls the first temperature door 330 and the second temperature door 340 so as to partially open the first flow path P1 and the second flow path P2, and controls the first door 310 and the second door 320 so as to partially open the first inlet 150 and the second inlet 160. In this case, the air passing through the first inlet 150 and the air passing through the second inlet 160 are mixed in the temperature control area 220. Thereafter, the mixed air is discharged to the rear seat.

In addition, when the interior temperature is lower than or higher than the set temperature stored in the controller 400 and a difference between the interior temperature and the set temperature is within a predetermined range, the controller 400 controls the first temperature door 330 and the second temperature door 340 so as to open the first flow path P1 and the second flow path P2 for fine adjustment of the temperature. Furthermore, the controller 400 rotates the first door 310 and the second door 320 so as to open the first inlet 150 and the second inlet 160.

In this case, in a state in which the first flow path P1 and the second flow path P2 are both opened, the air flowing into the case front portion 140 may flow to the upper end inside the air-conditioning case 100, the lower end inside the air-conditioning case 100, and the heater unit 120. Here, the low-temperature air that has passed through the evaporator 110 and the high-temperature air that has passed through the heater unit 120 may be mixed in the upper end inside the air-conditioning case 100 and the lower end inside the air-conditioning case 100. The mixed air may be discharged to the rear seat or may be discharged to the front seat according to the front seat air-conditioning mode.

Furthermore, when the interior temperature is less than or exceeds the set temperature stored in the controller 400 and a difference between the interior temperature and the set temperature falls within a predetermined range, the controller 400 may rotate the first door 310 and the second door 320 differently such that the opening degrees of the first door 310 and the second door 320 are differently adjusted. In this manner, the temperature of the vehicle interior may be maintained at the set temperature.

For example, when it is necessary to increase the temperature of the vehicle interior, the controller 400 rotates the first door 310 in a direction in which the opening degree of the first inlet 150 is increased. Conversely, when it is necessary to lower the temperature of the vehicle interior, the controller 400 rotates the second door 320 in a direction in which the opening degree of the second inlet 160 is increased.

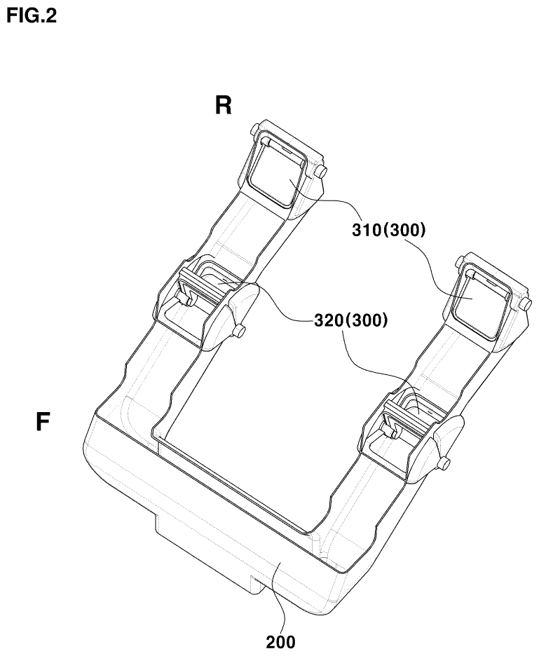

FIG. 2 is a perspective view of the rear seat duct unit 200.

According to an embodiment of the present disclosure, the rear seat duct units 200 respectively extend from opposite sides of the lower end of the air-conditioning case 100 toward the front end of the air-conditioning case 100. Furthermore, the rear seat duct units 200 extend in a direction facing each other at the front end of the air-conditioning case 100. In this manner, the rear seat duct units are formed to be integrated with each other. In other words, since the rear seat duct units 200 are fluidly connected to the front end of the air-conditioning case 100, air introduced from one of the rear seat duct units 200 and air introduced from the other of the rear seat duct units 200 are mixed at the lower end of the front end of the air-conditioning case 100. Then, the mixed air is discharged to the rear seat.

The first door 310 is rotated around a shaft penetrating the upper end of the bent portion 210 of the rear seat duct unit 200. Furthermore, the first door 310 is located obliquely, facing the first inlet 150 at the upper end of the bent portion 210. In addition, the first door 310 may be manufactured in a flap shape.

In addition, the first door 310 may be rotated around the shaft in a direction toward the upper end of air-conditioning case 100 or in a direction toward the lower end of the air-conditioning case 100. When the first door 310 is rotated in a direction toward the upper end of the air-conditioning case 100, the first inlet 150 is opened. Conversely, when the first door 310 is rotated in a direction toward the lower end of the air-conditioning case 100, the first inlet 150 is closed.

In other words, when the temperature of the rear seat needs to rise, the first door 310 is moved in a direction toward the upper end of the air-conditioning case 100 so as to open the first inlet 150. At this time, high-temperature air is introduced through the first inlet 150 and is discharged to the rear seat along the bent portion 210. When the temperature of the rear seat needs to be lowered, the first door 310 is rotated toward the lower end of the air-conditioning case 100 so as to close the first inlet 150.

In addition, the first door 310 may be positioned to be higher than the second door 320 in the vehicle height direction.

The second door 320 may be located adjacent to the second inlet 160 at the lower end of the heater unit 120. The second door 320 is designed to open the second inlet 160 and may be formed in a fan shape. Furthermore, the second door 320 may be formed in a V-Shape shape. An upper portion of the second door 320 is formed to have a curved surface, and both sides of the curved surface of the upper portion of the second door 320 extend to the lower end of the second door 320. Moreover, since the upper portion of the second door 320 is formed to have a curved surface, air facing the curved surface of the second door 320 flows along the curved surface. In this process, a sudden change in the air flow direction is prevented, thereby reducing the occurrence of turbulence.

In addition, the interior of the second door 320 is formed to be open. Furthermore, a rotation shaft is provided at both ends extending from both sides of the upper curved surface of the second door 320 to the lower end. The rotation shaft penetrates the rear seat duct unit 200 located at the lower end of the second inlet 160. Therefore, the second door 320 is rotated around the shaft.

When the second door 320 is rotated by its maximally rotatable angle in a direction toward the front end of the air-conditioning case 100, the second inlet 160 is closed. In this case, air introduced into the case front portion 140 may not be discharged to the rear seat through the second inlet 160. However, air introduced into the case rear portion 130 is introduced through the first inlet 150 when the first door 310 is opened. Then, the air flows to the second door 320 along the bent portion 210. The air flowing to the second door 320 along the bent portion 210 may be discharged to the rear seat while passing through the interior of the second door 320 having an open structure.

In addition, when the second door 320 is rotated by the maximally rotatable angle in a direction toward the rear end of the air-conditioning case 100, the second inlet 160 is fully opened, and a passage facing the bent portion 210 is closed. Therefore, air passing through the case front portion 140 may be discharged to the rear seat along the second inlet 160, but air passing through the case rear portion 130 may not be discharged to the rear seat.

Furthermore, when the second door 320 is rotated by a predetermined opening degree in the direction toward the rear end of the air-conditioning case 100, the second inlet 160 is opened, and the passage facing the bent portion 210 is also opened. Therefore, air passing through the case front portion 140 is introduced into the second inlet 160. In this case, when the first door 310 is rotated to open the first inlet 150, air passing through the case rear portion 130 is introduced into the first inlet 150. The air introduced into the first inlet 150 may pass through the interior of the second door 320 and may be mixed with the air introduced into the second inlet 160 in the temperature control area 220. Thereafter, the mixed air may be discharged to the rear seat.

Further, the second door 320 may be located to be lower than the first door 310 in the vehicle height direction. In addition, the second door 320 may be located closer to the front end of the air-conditioning case 100 than the first door 310. In this manner, air passing through the first door 310 is designed to flow toward the second door 320.

The temperature control area 220 is located adjacent to the second door 320. When the first door 310 and the second door 320 are rotated to open the first inlet 150 and the second inlet 160, air passing through the first inlet 150 and air passing through the second inlet 160 are introduced and mixed in the temperature control area, thereby controlling the temperature to be discharged to the rear seat. Therefore, the opening degree of each of the first inlet 150 and the second inlet 160 is determined based on a temperature setting value by a user, and the air introduced into the temperature control area 220 through the first inlet 150 and the air introduced into the temperature control area 220 through the second inlet 160 are mixed in the temperature control area.

FIG. 3A is a side cross-sectional view of the vehicle air conditioner 10, FIG. 3B is a plan view of a section taken along line A-A in FIG. 3A, and FIG. 3C is a side view of a section taken along line B-B in FIG. 3B.

The rear seat duct units 200 of the present disclosure are respectively provided on both sides of the lower end of the air-conditioning case 100 and extend in the longitudinal direction along the lower end surface of the air-conditioning case 100. In addition, the rear seat duct units 200 are configured to extend along the lower end surface of the air-conditioning case 100, to extend in a direction facing each other along an outer surface of the air-conditioning case 100, the outer surface being adjacent to the lower end of the evaporator 110, and to be fluidly connected to each other.

Additionally, the rear seat duct units 200 are configured such that they become closer (i.e., approach) to the vehicle body in a direction extending from the rear end to the front end of the air-conditioning case 100. Furthermore, the bent portions 210 are respectively located at the upper ends of the rear seat duct units 200, and the respective lower ends of the rear seat duct units 200 extend in a direction facing each other.

Through this structure, the air introduced into the bent portion 210 flows from the rear end of the air-conditioning case 100 to the front end of the air-conditioning case 100 in a direction toward the vehicle body and is mixed with the air that has passed through the second inlet 160 in the temperature control area 220. The mixed air flows to the respective lower ends of the rear seat duct units 200, and the mixed air present in one of the rear seat duct units 200 and the mixed air present in the other thereof flow in a direction facing each other at the lower ends of the rear seat duct units 200. The introduced air is mixed at the lower ends of the rear seat duct units 200 and then is discharged to a rear seat vent (not shown).

According to an embodiment of the present disclosure, the controller 400 is configured to compare the temperature of the vehicle interior with the set temperature and control the first temperature door 330, the second temperature door 340, the first door 310, and the second door 320 so as to maintain the set temperature.

The controller 400 performs control to increase the temperature of the vehicle interior when the temperature of the vehicle interior is lower than the set temperature stored in controller 400. Furthermore, when a difference between the temperature of the vehicle interior and the set temperature exceed a predetermined range stored in controller 400, the controller 400 performs control to cause all of the air that has passed through evaporator 110 to flow to the heater unit 120.

First, the controller 400 controls the first temperature door 330 and the second temperature door 340 so as to fully open the second flow path P2 and close the first flow path P1. When the second flow path P2 is opened, the air that has passed through the evaporator 110, i.e., the air flowing to the case front portion 140, flows to the heater unit 120 through the second flow path P2. In this case, the air flowing to the heater unit 120 exchanges heat with the interior condenser 122 to increase the temperature. When the PTC heater 121 is operated as necessary, the temperature increases by absorbing heat from the PTC heater 121.

The high-temperature air flows to the case rear portion 130. At this time, the first door 310 is rotated to open the first inlet 150. Therefore, air flowing into the case rear portion 130 may flow into the upper end inside the air-conditioning case 100 and the first inlet 150. Here, the flow direction of the high-temperature air flowing into the first inlet 150 is changed such that the high-temperature air flows to the front end of the air-conditioning case 100 through the bent portion 210. In this case, the high-temperature air may flow along the curved surface of the extension portion 230, and the flow direction of the high-temperature air may be gradually changed toward the front end of the air-conditioning case 100.

In other words, the flow direction of the air is changed in a direction toward the second inlet 160, flows along the rear seat duct unit 200, and is discharged to the rear vent.

In this case, when the first flow path P1 is closed, air that has passed through the evaporator 110 may not directly flow to the upper end inside the air-conditioning case 100 and the lower end inside the air-conditioning case 100. In this case, the air may first pass through the heater unit 120 and then may flow to the upper end inside the air-conditioning case 100 and the lower end inside the air-conditioning case 100. Through this structural configuration, the temperature of the vehicle interior rises.

In addition, when the temperature of the vehicle interior is lower than the set temperature stored in the controller 400, and a difference between the temperature of the vehicle interior and the set temperature falls within a predetermined range stored in the controller 400, the controller 400 performs temperature control by mixing the air that has passed through the evaporator 110 and the air that has passed through the heater unit 120.

In this case, the controller 400 moves the first temperature door 330 and the second temperature door 340 so as to open both the first flow path P1 and the second flow path P2. At this time, a part of the low-temperature air flowing to the case front portion 140 flows to the upper end inside the air-conditioning case 100 through the first flow path P1. In other words, the temperature of the air discharged to the duct through the air-conditioning case 100 may be appropriately set by controlling the opening degree of each of the first temperature door 330 and the second temperature door 340.

The air flowing to the upper end inside the air-conditioning case 100 is discharged directly to the front seat in response to the air-conditioning mode. Alternatively, the above-mentioned air is mixed with the air that has passed through the heater unit 120 and has the increased temperature at the upper end inside the air-conditioning case 100, and then the mixed air is discharged to the front seat.

In addition, the controller 400 opens the first door 310 and the second door 320 so as to open the first inlet 150 and the second inlet 160. In this case, the controller 400 may control the first door 310 in a direction in which the opening degree of the first door 310 is increased. In an embodiment, the controller 400 controls the first door 310 so that the opening degree of the first door 310 is greater than the opening degree of the second door 320. Through this configuration, the amount of high-temperature air flowing into the first inlet 150 may be greater than the amount of low-temperature air flowing into the second inlet 160.

Furthermore, as shown in the drawing, the air passing through the first inlet 150 may flow to the rearmost end of the air-conditioning case 100 through the extension portion 230, and then the flow direction of the air may be changed to face the front end of the air-conditioning case 100 along the curved surface of the extension portion 230.

The air passing through the case rear portion 130 may be introduced into the rear seat duct unit 200 through the second inlet 160, the air passing through the case rear portion 130 may be introduced into the rear seat duct unit 200 through the first inlet 150, and the airs may be mixed in the temperature control area 220 to control the temperature of the air to be discharged. In this manner, the mixed air may be discharged to the rear end.

The controller 400 performs control to lower the temperature of the vehicle interior when the temperature of the vehicle interior exceeds the set temperature stored in the controller 400. Furthermore, when a difference between the temperature of the vehicle interior and the set temperature exceeds a predetermined range stored in the controller 400, the controller 400 controls the first temperature door 330 and the second temperature door 340 such that all of the air passing through the evaporator 110 may directly flow to the upper end inside the air-conditioning case 100 and the lower end inside the air-conditioning case 100 without passing through the heater unit 120.

In this case, the controller 400 moves the first temperature door 330 and the second temperature door 340 in a direction in which the second flow path P2 is fully closed. Due to movement of the first temperature door 330 and the second temperature door 340, the first flow path P1 is fully opened and the second flow path P2 is closed. Through this structural configuration, the low-temperature air that has passed through the evaporator 110 may flow into the upper end inside the air-conditioning case 100 and the lower end inside the air-conditioning case 100 without passing through the heater unit 120. At this time, the second door 320 is rotated in a direction in which the second inlet 160 is opened.

Therefore, the air flowing into the lower end inside the air-conditioning case 100 may be discharged to the rear seat through the second inlet 160 along the rear seat duct unit 200. Furthermore, the low-temperature air flowing into the upper end inside the air-conditioning case 100 through the first flow path P1 may be discharged to the front seat according to the air-conditioning mode.

In addition, in this case, the second door 320 is rotated in the direction in which the second inlet 160 is closed, air may not be introduced through the second inlet 160.

Additionally, when the temperature of the vehicle interior exceeds the set temperature stored in the controller 400, and a difference between the temperature of the vehicle interior and the set temperature falls within a predetermined range stored in the controller 400, the controller 400 performs temperature control by mixing the air that has passed through the evaporator 110 and the air that has passed through the heater unit 120.

In this case, the controller 400 opens all of the first flow path P1, the second flow path P2, and the third flow path P3. Here, a part of the low-temperature air that has been introduced into the case front portion 140 flows to the upper end inside the air-conditioning case 100 through the first flow path P1, a part of the low-temperature air passes through the heater unit 120 through the second flow path P2 so as to increase the temperature, and the remaining low-temperature air flows to the lower end inside the air-conditioning case 100 through the third flow path P3.

In addition, the controller 400 opens the first door 310 and the second door 320 so as to open the first inlet 150 and the second inlet 160, and the controller 400 may control the second door 320 in a direction in which the opening degree of the second door 320 is increased. In an embodiment, the controller 400 controls the first door 310 and the second door 320 such that the opening degree of the second door 320 is greater than the opening degree of the first door 310. Through this structural configuration, the amount of low-temperature air flowing into the second inlet 160 may be greater than the amount of high-temperature air flowing into the first inlet 150.

In this manner, fine temperature control may be performed by controlling the opening degrees of the first door 310 and the second door 320.

In summary, the present disclosure provides a structure in which air that has passed through the evaporator 110 and the heater unit 120 is discharged to the rear seat through the rear seat duct unit 200, and the flow direction of air that has passed through the first inlet 150 is changed toward the front end of the air-conditioning case 100 along the extension portion 230 protruding toward the outer surface of the air-conditioning case 100 and having the curved surface, thereby effectively preventing turbulence occurrence. In addition, according to technical features of the present disclosure, the opening degrees of the first door 310 and the second door 320 are adjusted differently so as to effectively perform fine temperature control. In this manner, it is possible to maintain the set temperature in the vehicle interior.

As is apparent from the above description, the present disclosure may achieve the following effects by the configuration, combination, and use relationship described in the embodiments.

First, rear seat duct units are respectively provided on both sides of a front seat mixing zone so as to prevent interference with a sliding console, thereby having an effect of more efficiently utilizing an interior space of a vehicle. Through this structural configuration, the interior space is more efficiently used, thereby improving passenger convenience.

Second, cooling and heating performance of a rear seat may be improved by optimizing the locations of the rear seat duct units and maintaining balance of the flow of the conditioned air. In this manner, it is possible to maintain a comfortable temperature inside the vehicle, and to improve energy efficiency of an air-conditioning system.

Third, maintenance frequency of the air-conditioning system may be reduced by designing a duct unit and an air-conditioning flow path without interference therebetween, thereby having an effect of improving durability of the system. Through this structural configuration, maintenance costs may be reduced, and reliability of the system may be improved.

The present disclosure has been described in detail with reference to some embodiments thereof, and the present disclosure may be used in various other combinations, modifications, and environments. It should be appreciated by those having ordinary skill in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A vehicle air conditioner comprising:
an air-conditioning case;
an evaporator located inside of the air-conditioning case;
a heater unit located at a rear end of the evaporator;
a case rear portion located at a rear end of the heater unit and configured to guide air that has passed through the heater unit;
first inlets located facing the case rear portion;
rear seat duct units respectively located at opposite sides of the air-conditioning case, the rear seat duct units being fluidly connected to the respective first inlets; and
rear seat door units configured to selectively open and close the respective rear seat duct units,
wherein the rear seat duct units respectively comprise the first inlets and bent portions, and each of the bent portions is configured to redirect the air introduced from the case rear portion toward a front end of the air-conditioning case.

2. The vehicle air conditioner of claim 1, further comprising:
a case front portion located between the evaporator and the heater unit and configured to guide air that has passed through the evaporator; and
second inlets located facing the case front portion,
wherein the rear seat duct units are fluidly connected to the respective second inlets.

3. The vehicle air conditioner of claim 2, wherein the rear seat door units comprise:
first doors configured to open and close the respective first inlets; and
second doors configured to open and close the respective second inlets.

4. The vehicle air conditioner of claim 3, wherein each of the rear seat duct units comprises a temperature control area adjacent to the second inlet, each of the temperature control areas configured to mix air introduced through a corresponding first inlet among the first inlets with air introduced through a corresponding second inlet among the second inlets.

5. The vehicle air conditioner of claim 3, further comprising a controller configured to receive an interior temperature from a vehicle interior sensor and to operate the first doors and the second doors.

6. The vehicle air conditioner of claim 5, wherein when the interior temperature of a rear seat falls below a set temperature by more than a preset allowable range, the controller is configured to control the first doors so as to open the respective first inlets and control the second doors so as to close the respective second inlets.

7. The vehicle air conditioner of claim 5, wherein when the interior temperature of a rear seat exceeds a set temperature by more than a preset allowable range, the controller is configured to control the first doors so as to close the respective first inlets and control the second doors so as to open the respective second inlets.

8. The vehicle air conditioner of claim 5, wherein when the interior temperature of a rear seat is lower than a set temperature and a difference between the interior temperature of the rear seat and the set temperature falls within a preset allowable range, the controller is configured to control the first doors so as to increase respective opening degrees of the first doors.

9. The vehicle air conditioner of claim 5, wherein when the interior temperature of a rear seat exceeds a set temperature and a difference between the interior temperature of the rear seat and the set temperature falls within a preset allowable range, the controller is configured to control the second doors so as to increase respective opening degrees of the second doors.

10. The vehicle air conditioner of claim 1, wherein the heater unit comprises:
a positive temperature coefficient (PTC) heater located adjacent to the first inlets; and
an interior condenser located between the evaporator and the PTC heater.

11. The vehicle air conditioner of claim 1, wherein each of the bent portions comprises an extension portion protruding from an outer surface of a rear end of the air-conditioning case.

12. A vehicle air conditioner comprising:
an air-conditioning case;
an evaporator located inside of the air-conditioning case;
a heater unit located at a rear end of the evaporator;
a case rear portion located at a rear end of the heater unit and configured to guide air that has passed through the heater unit;
a case front portion located between the evaporator and the heater unit and configured to guide air that has passed through the evaporator;
a pair of rear seat duct units respectively disposed on opposite sides of the air-conditioning case, each rear seat duct unit including a first door and a second door; and
a controller configured to respectively control the first and second doors to adjust amounts of air introduced from the evaporator and the heater unit, respectively.

13. The vehicle air conditioner of claim 12, wherein each of the pair of rear seat duct units comprises:
a first inlet configured to pass the air from the heater unit;
a second inlet configured to pass the air from the evaporator; and
a temperature control area adjacent to the second inlet, the temperature control area configured to mix the air introduced through the first inlet with the air introduced through the second inlet.

14. The vehicle air conditioner of claim 13, wherein the first door is configured to open and close the first inlet; and the second door is configured to open and close the second inlet.

15. The vehicle air conditioner of claim 13, wherein the pair of rear seat duct units respectively extend from a rear end of the air-conditioning case to a front end of the air-conditioning case along lower end surfaces of the opposite sides of the air-conditioning case.

16. The vehicle air conditioner of claim 15, wherein the first inlets of the pair of rear seat duct units face a case rear portion located at a rear end of the heater unit, and the second inlets of the pair of rear seat duct units face a case front portion located between the evaporator and the heater unit.

17. The vehicle air conditioner of claim 13, wherein when an interior temperature of a rear seat falls below a set temperature by more than a preset allowable range, the controller is configured to control the first doors so as to open the respective first inlets and control the second doors so as to close the respective second inlets.

18. The vehicle air conditioner of claim 13, wherein when an interior temperature of a rear seat exceeds a set temperature by more than a preset allowable range, the controller is configured to control the first doors so as to close the respective first inlets and control the second doors so as to open the respective second inlets.

19. The vehicle air conditioner of claim 13, wherein when an interior temperature of a rear seat exceeds a set temperature and a difference between the interior temperature of the rear seat and the set temperature falls within a preset allowable range, the controller is configured to control the second doors so as to increase respective opening degrees of the second doors.
